(19) United States
(12) Patent Application Publication
(10) Pub. No.: US 2010/0289764 A1
(43) Pub. Date: Nov. 18, 2010

(54) ELECTRONIC DEVICE, DISPLAYING METHOD, AND RECORDING MEDIUM

(75) Inventors: Masayuki Akabe, Kawasaki (JP); Kazuyuki Yamamura, Kawasaki (JP); Katsuaki Akama, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/767,988

(22) Filed: Apr. 27, 2010

(30) Foreign Application Priority Data
May 13, 2009 (JP) 2009-116531

(51) Int. Cl. G06F 3/041; G06F 3/033

(52) U.S. Cl. 345/173; 715/863

(57) ABSTRACT

An electronic device including a display unit which displays a first selection image which is selectable by touching a screen with an object and a display control unit which controls display of a second selection image corresponding to the first selection image displayed within a prescribed range based on a position in which the object touches in the screen.

### CROSS-REFERENCE TO RELATED APPLICATIONS

This application is based upon and claims the benefit of priority from the prior Japanese Patent Application No. 2009-116531 filed on May 13, 2009, the entire contents of which are incorporated herein by reference.

### FIELD

The present invention relates to an electronic device, a displaying method, and a recording medium. The present invention relates to, for example, an electronic device, and a displaying method, and a recording medium that display a selection image that is selectable by touching a screen with an object.

### BACKGROUND

An electronic device that includes a touch panel is used in many cases. The above-described electronic device displays one or more selection images (e.g., buttons) that are selectable on a display screen of a touch panel. When a contact member such as a finger touches one of the selection images, the selection image is selected. For example, when a displayed selection image is selected, a browser program displays a page that is linked from the selection image.

Japanese Laid-open patent publication No. 2001-109557 discloses a technique for enlarging and displaying the vicinity of a part selected on the display screen of a plurality of selections. Japanese Laid-open patent publication No. 2002-77357 discloses a technique for preventing a display from being hidden by a finger when a selection item is selected by positioning a touch panel switch in a position that is different from the position of a display unit.

The selection image is hidden by a finger or the like touching the touch panel when a small selection image is displayed on the display screen of the display unit having the touch panel. For example, when a plurality of selection images, which may be hidden by a finger or the like, are displayed, a user may not recognize which selection image is touched by the finger or the like. If the technique of Japanese Laid-open patent publication No. 2002-77357 is used to solve the above-described problem, selection items may be misidentified.

### SUMMARY

According to an aspect of the invention, an electronic device includes: a display unit which displays a first selection image which is selectable by touching a screen with an object and a display control unit which controls display of a second selection image corresponding to the first selection image displayed within a prescribed range based on a position in which the object touches in the screen.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a block diagram of a mobile phone terminal according to a first embodiment,

FIG. 2A is a diagram illustrating a display screen of a display unit describing a principle of the first embodiment,

FIG. 2B is a diagram illustrating a display screen of a display unit describing a principle of the first embodiment,

FIG. 3 is a flowchart illustrating control of a display control unit according to the first embodiment,

FIG. 4 is a flowchart illustrating a flow of Operation S14 of FIG. 3,

FIG. 5 is a diagram illustrating a display screen of a display unit,

FIG. 6 is a flowchart illustrating a flow of Operation S16 of FIG. 3,

FIG. 7A is a diagram illustrating another display screen of the display unit,

FIG. 7B is a diagram illustrating another display screen of the display unit,

FIG. 8 is a flowchart illustrating a flow of Operation S18 of FIG. 3, and

FIG. 9 is a diagram illustrating another display screen of the display unit.

### DESCRIPTION OF THE EMBODIMENTS

With reference to the diagrams, description will be made below of embodiments of a displaying method of a mobile phone terminal as an example.

### First Embodiment

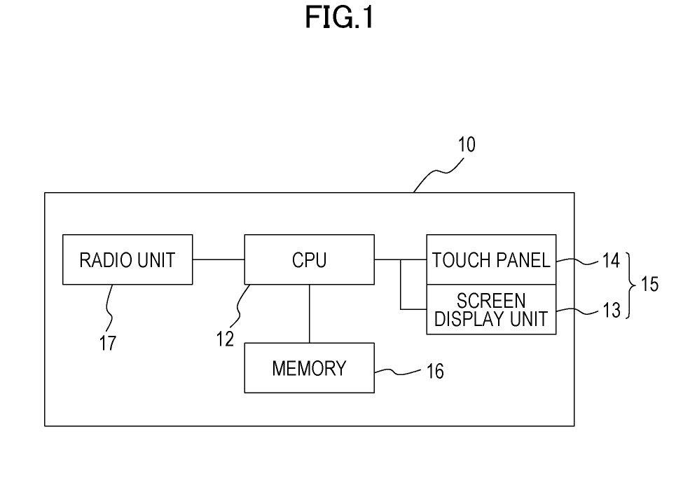

FIG. 1 is a block diagram of a mobile phone terminal according to a first embodiment. As illustrated in FIG. 1, a mobile phone terminal 10 includes a Central Processing Unit (CPU) 12, a display unit 15, a memory 16, and a radio unit 17. The CPU 12 functions as a display control unit that controls the display unit 15. The CPU 12 further controls the radio unit 17. The display unit 15 includes, for example, a screen display unit 13 that is a liquid crystal display device and a touch panel 14, and displays a selection image that allows the user to select a link destination, for example. The user may select a selection image to display a page of a desired link by touching the display screen of the display unit 15 with a finger or the like. The memory 16 is a volatile memory or a nonvolatile memory that stores the selection image and detailed information thereof. The radio unit 17 communicates with a base station.

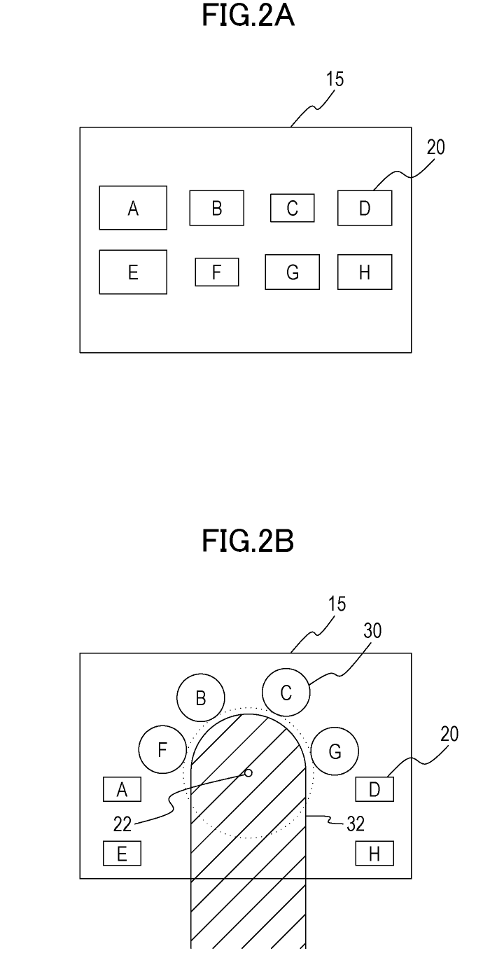

FIG. 2 is a diagram illustrating a display screen of the display unit describing a principle of the first embodiment. As illustrated in FIG. 2A, the display unit 15 displays images A to H as a plurality of selection images 20. The selection images 20 are selectable by being touched with an object such as a finger 32. For example, the selection image 20 is an image to select a link destination on the screen displayed on a browser. The selection image 20 may be a character string, an image, or a combination thereof. As illustrated in FIG. 2B, when the finger 32 touches the display screen, the display control unit displays a selection image 30, from among the selection images 20 displayed on the display screen, corresponding to the selection image 20 that is hidden by the finger 32 outside an area hidden by the finger 32. In FIG. 2B, the images B, C, F, and G may be displayed as selection images 30 outside an outline of the finger 32. At this time, the selection image 20 hidden by the finger 32 may remain displayed or may be controlled not to be displayed. Furthermore, the selection image 20 itself may move to become the selection image 30. In a state where the finger 32 slides on the display screen to select one (e.g., the image B) of the selection images 30 and is then separated from the display screen, the display control unit determines that the selection image 30 (e.g., the image B) is selected.

As described above, when the user's finger touches the selection image 20 on the display screen, the selection image moves to the outside of the finger. Thus, the user may visually recognize the selection image 30. Description will be made of an example of a case where the number of the selection images 20 and 30 is plural. The number of the selection images 20 and 30 may be single.

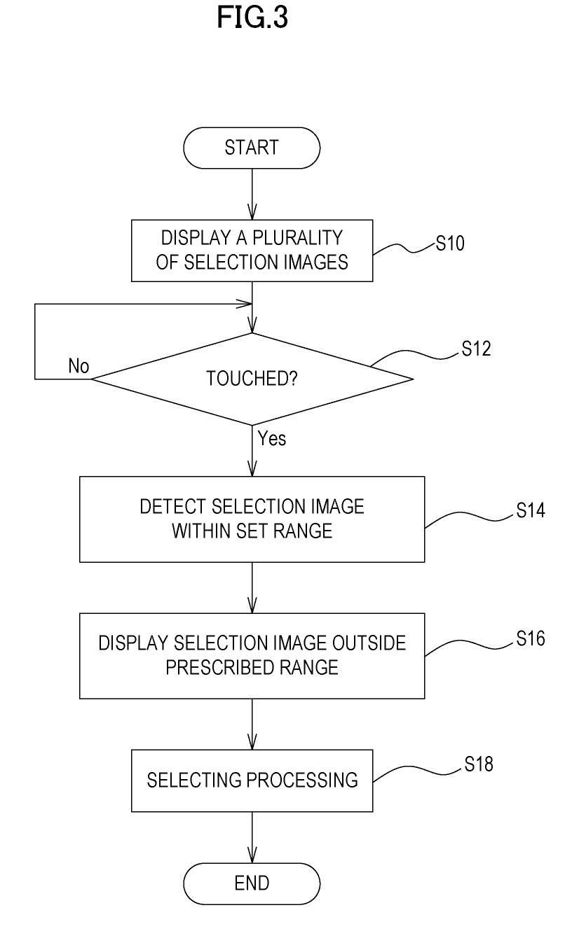

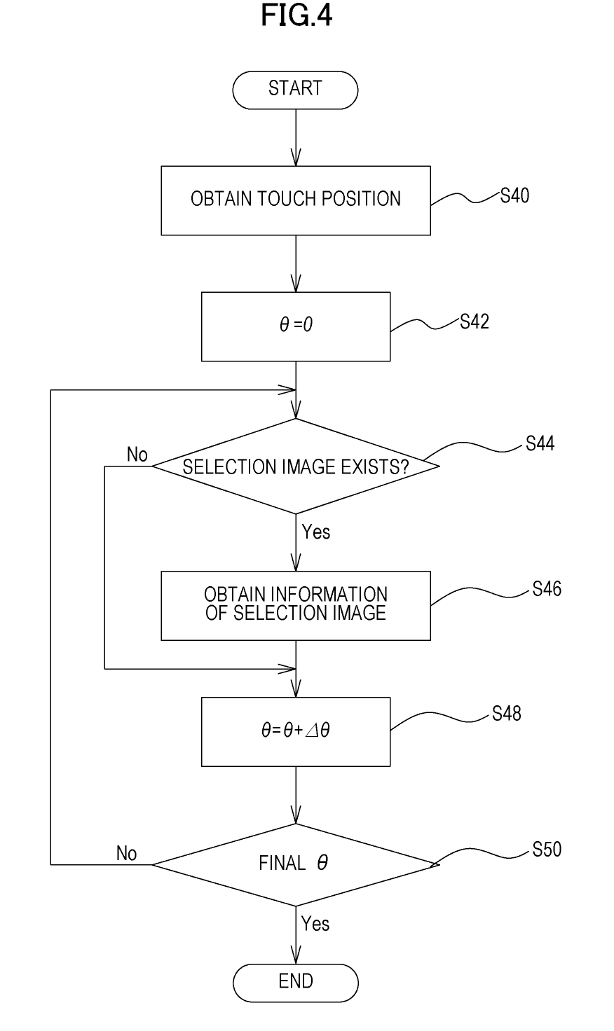

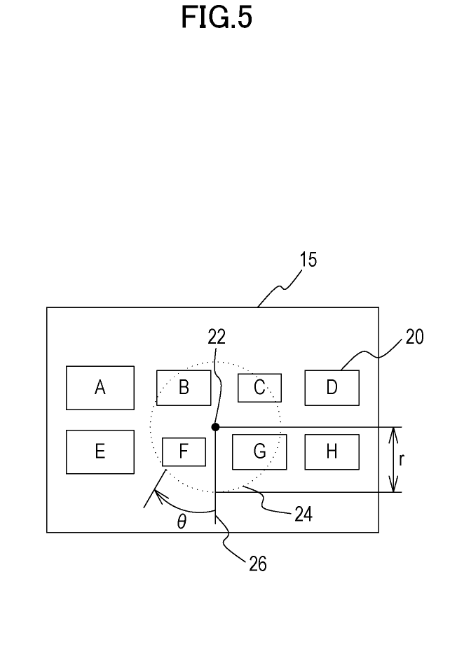

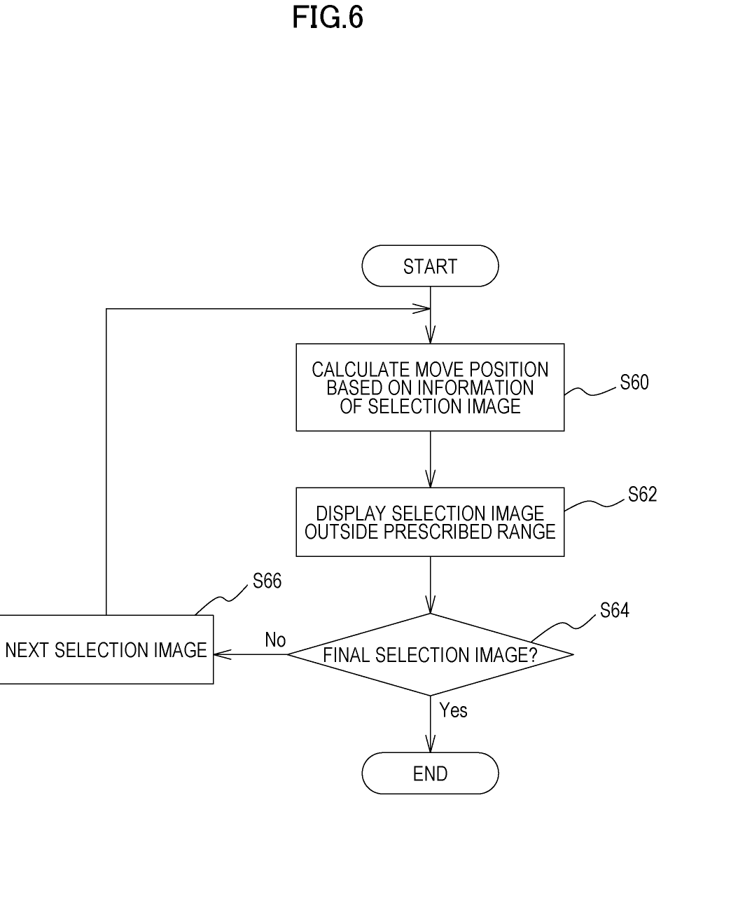

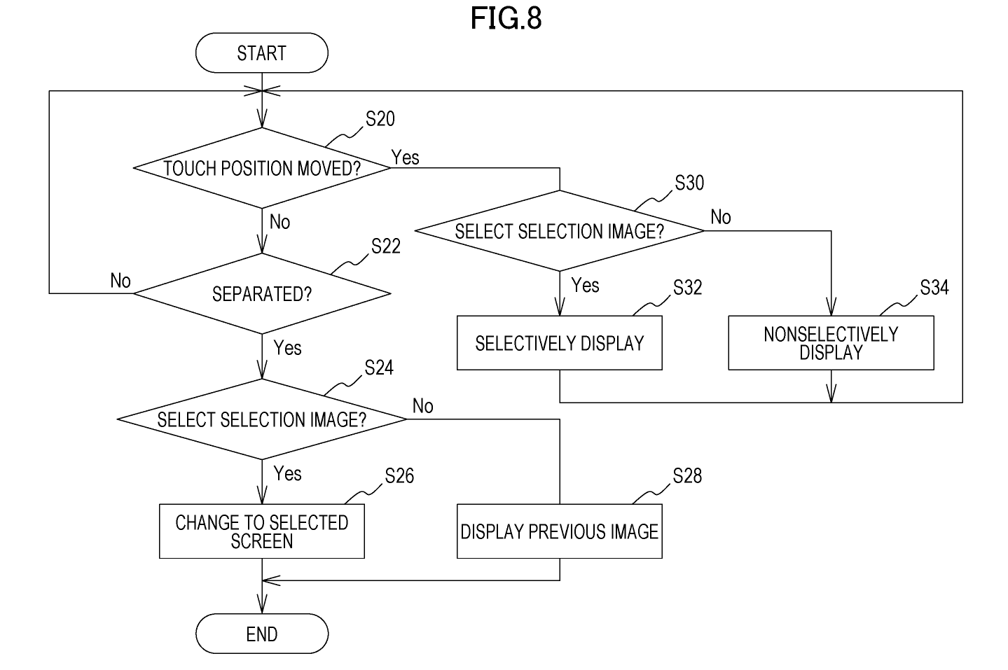

FIG. 3 is a flowchart illustrating control of the display control unit according to the first embodiment. As illustrated in FIG. 3, the display control unit displays a plurality of selection images 20 on the display unit 15 (Operation S10). The display control unit determines whether or not the finger 32 touches the display screen (Operation S12). If no, the process goes back to Operation S12. If yes, the display control unit detects the selection image 20 within a prescribed range 24 (see FIG. 5) that is hidden by the finger 32 on the display screen (Operation S14). The flowchart will be described in detail by using FIG. 4. The display control unit displays the detected selection image 30 outside the prescribed range 24 (Operation S16). The flowchart will be described in detail by using FIG. 6. The display control unit performs selecting processing for determining whether or not the selection image 30 is selected (Operation S18). The flowchart will be described in detail by using FIG. 8.

FIG. 4 is a flowchart illustrating a flow of Operation S14 of FIG. 3. FIG. 5 is a diagram illustrating the display screen of the display unit. As illustrated in FIG. 4, the display control unit obtains a touch position of the finger 32 from the touch panel 14 (Operation S40). As illustrated in FIG. 5, the touch panel 14 outputs a coordinate of a position 22 touched by the finger 32. In this example, the number of the positions 22 output from the touch panel 14 is single. As illustrated in FIG. 4, the display control unit defines θ=0 (Operation S42). In FIG. 5, for example, the center is the position 22, and the angle from a line 26 is θ. As illustrated in FIG. 4, the display control unit determines whether or not the selection image 20 exists between the position 22 and a prescribed distance r (Operation S44). If no, the process goes to Operation S48. If yes, the display control unit obtains information of the selection image 20 between the position 22 and the prescribed distance r (Operation S46). The information of the selection image 20 may be, for example, a character string, an image, a color, a size, a link destination URL displayed on the selection image 20, a distance from the touch position 22, an angle θ, and the like. The display control unit defines angle θ=θ+θ (Operation S48). The display control unit determines whether or not the angle θ is the final θ (Operation S50). That is, the display control unit determines whether or not searching for the selection image 20 for 360 degrees is finished. If no, the process goes back to Operation S44. If yes, the process is ended.

By the above-described processing, as illustrated in FIG. 5, the images B, C, F, and G are detected as the selection images 20 within the prescribed range 24 that is a circle with a radius r and the position 22 as the center thereof. In Operation S44, the selection image 20 may be determined to be detected depending on whether or not the selection image 20 is completely included in the prescribed range 24. Furthermore, the selection image 20 may be determined to be detected depending on whether or not at least a part of the selection image 20 is included in the prescribed range 24. Moreover, the selection image 20 may be determined to be detected depending on whether or not a fixed ratio of the selection image 20 is included in the prescribed range 24.

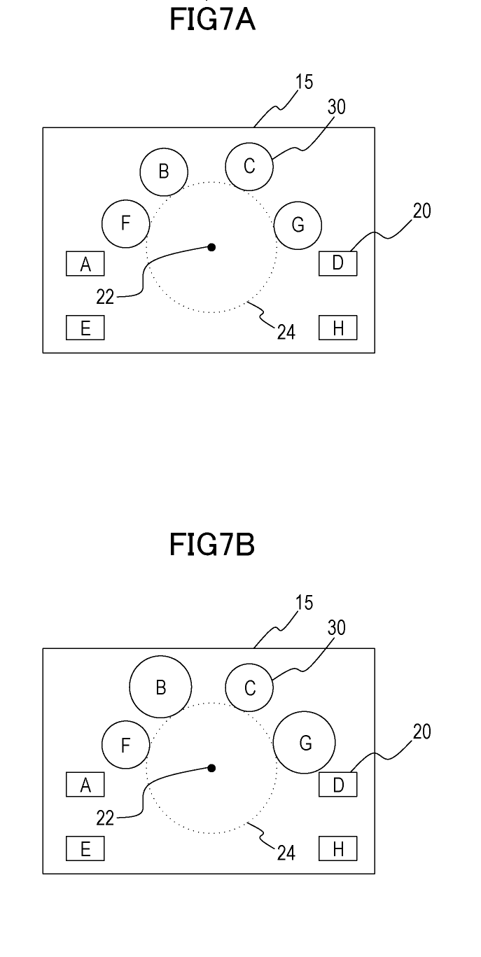

FIG. 6 is a flowchart illustrating a flow of Operation S16 of FIG. 3. FIGS. 7A and 7B are diagrams illustrating the display screen of the display unit. As illustrated in FIG. 6, based on the information of the selection image 20 obtained in Operation S46 for each of the selection images 20 (e.g., the images B, C, F, and G), the display control unit calculates a move position outside the prescribed range 24 of the selection image 20 (Operation S60). The display control unit displays the selection image 30 in the move position that is calculated in Operation S60 (Operation S62). At this time, the color and the size of the selection image 30, which is to be displayed based on the information of the selection image 20, may vary. The display control unit determines whether or not the selection image 30 is the final selection image 30 (Operation S64). If no, the display control unit determines that the selection image 30 to be processed is the next selection image 30 (Operation S66). In Operation S64 to go back to Operation S60, if the display control unit determines that the processing on all the selection images 30 to be processed is completed (YES in Operation S64), the processing in Operation S16 of FIG. 3 is ended.

By the above-described processing, as illustrated in FIG. 7A, the images B, C, F, and G from among the selection images 20 are displayed as the selection images 30 outside the prescribed range 24. When the prescribed range 24 is as large as the finger 32, as illustrated in FIG. 2B, the images B, C, F, and G as the selection images 30 may be displayed outside the finger 32.

In Operation S60 of FIG. 6, the display control unit may determine the display position of the selection image 30 in a position where a move distance of the selection image 20 is short so that the user may easily recognize the selection image 30. In Operation S60 of FIG. 6, as illustrated in FIG. 7B, the selection images 20 (e.g., the images B and G) that are large in size in FIG. 2A may be enlarged and displayed after the movement thereof. As described above, the size of the selection image 30 after the movement thereof may be determined according to the size of the selection image 20 before the movement thereof. The selection images 20 (e.g., the images A, D, E, and H) that were not moved may be reduced and displayed or may be undisplayed or transparently displayed. Furthermore, the display position of the selection image 20 may be changed.

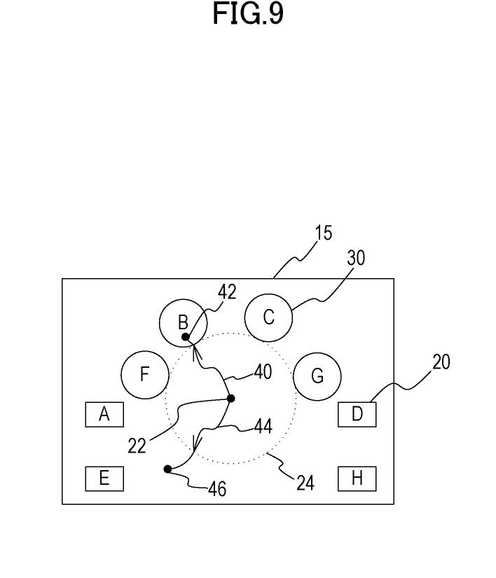

FIG. 8 is a flowchart illustrating a flow of Operation S18 of FIG. 3. FIG. 9 is a diagram illustrating the display screen of the display unit. As illustrated in FIG. 8, the display control unit determines whether or not the touch position has moved (Operation S20). In this case, the movement of the touch position defines movement of the finger 32 in a state that the finger 32 is touching the display screen. Even if the finger 32 is separated from the display screen, the display control unit may recognize that the finger 32 is moving in the state that the finger 32 is touching the display screen only within a prescribed time. If no, the display control unit determines whether or not the finger 32 is separated from the display screen (Operation S22). If no, the process goes back to Operation S20. If yes, the display control unit determines whether or not the selection image 30 is selected (Operation S24). For example, when the finger 32 is separated from the display screen, the display control unit determines that the selection image 30 is selected if the touch position is within any of the selection images 30. When the finger 32 is separated from the display screen, the display control unit determines that none of the selection images 30 is selected if the touch position is not within any of the selection images 30.

If yes in Operation S24, the display control unit obtains data from a computer corresponding to a URL or similar defined by the selected selection image 30 and changes the screen to the screen for displaying the data (Operation S26). If no in Operation S24, the display control unit displays the image of FIG. 2A on the display screen (Operation S28). That is, in case the selection image 30 corresponding to the selection image 20 have been displayed, the selection image 30 is deleted and only the selection image 20 is displayed. Alternatively, in case the selection image 20 have been moved as the selection image 30, the moved image 20 is returned to the previous position which is within the prescribed range 24. If yes in Operation S20, the display control unit determines whether or not any of the selection images 30 is selected (Operation S30). If yes, the display control unit selectively displays the selected selection image 30 (Operation S32). For example, the color and the font of the selected selection image 30 are changed. Then the process goes back to Operation S20. If no in Operation S30, the display control unit nonselectively displays the selection image 30 (Operation S34). For example, the selection image 30 remains the same. After that, the process goes back to Operation S20.

For example, as illustrated in FIG. 9, the touch position goes along a route 40 from the position 22 to reach a position 42 in the state that the finger 32 is touching the display screen. Since the position 42 is included in the image B from among the selection images 30, the image B from among the selection images 30 is selectively displayed as illustrated in Operation S32. In this state, when the finger 32 is separated from the display screen, the screen is changed to the screen of the link destination corresponding to the image B from among the selection images 30 as illustrated in Operation S26. On the other hand, the touch position goes along the route 44 from the position 22 to reach a position 46 in the state that the finger 32 is touching the display screen, all the selection images 30 are nonselectively displayed as illustrated in Operation S34 because the position 46 is not included in any of the selection images 30. In this state, when the finger 32 is separated from the display screen, the image of FIG. 2A is returned as illustrated in Operation S28.

According to the first embodiment, as illustrated in FIG. 6 and FIG. 7A, the selection image 20, which is within the prescribed range 24 that includes the position 22 where the object such as the finger 32 touches on the display screen of the display unit 15, is displayed as the selection image 30 outside the prescribed range. This makes it possible to prevent the selection image 20 from being hidden by the finger 32. Thus, the user may easily select the selection image 30. The prescribed range 24 may be determined according to the object. For example, the size of the prescribed range 24 may be determined in advance according to an average size or a relatively large size of a finger. Accordingly, the size of the prescribed range 24 may be determined depending on the size of the object. If the object that touches the display screen is other than a finger, the size and the shape of the prescribed range 24 may be determined depending on the size of the object.

As illustrated in Operation S24 of FIG. 8, if the object such as the finger 32 moves to one of the selection images 30 (e.g., the image B) from among the selection images 30 displayed outside the prescribed range 24 and is then separated from the screen, it is preferred that the display control unit selects the selection image 30 (e.g., the image B) to which the object moved. This enables the user to easily select the selection image 30.

Furthermore, as illustrated in Operation S28 of FIG. 8, it is preferred that the display control unit displays the selection image 30, which is displayed outside the prescribed range 24 when the object such as the finger 32 is separated from the screen, within the prescribed range 24. As a result, the screen goes back to the screen of FIG. 2A.

Moreover, the plurality of selection images 30 corresponds to link destinations. As illustrated in Operation S26 of FIG. 8, it is preferred that the display control unit goes to the link destination corresponding to the selected selection image 30 (e.g., the image B). This enables the user to easily go to the link destination. The first embodiment describes an example of the image that allows the user to select the link destination as the selection images 20 and 30. The selection image may be an image for other selections.

The touch position detected by the touch panel 14 is near the center of the tip of the object (e.g., the finger 32). As illustrated in FIG. 7A, it is preferred that the prescribed range 24 is a circle with a radius that is as long as the radius of the tip of the object (e.g., the finger 32) and has the touch position 22 as the center thereof. This enables the user to more easily visually recognize the selection image 20 that is hidden by the object such as the finger 32. The number of the touch positions detected by the touch panel 14 may be plural. The prescribed range 24 includes at least one of the plurality of touch positions.

As illustrated in FIG. 7A, it is preferred that the display control unit displays the selection image 30, which is displayed outside the prescribed range 24, along the outline of the prescribed range 24. This enables the user to more easily visually recognize the selection image 30.

Furthermore, as illustrated in FIG. 2B, if the object is the finger 32, for example, it is difficult to visually recognize the lower side of the object. Therefore, it is preferred that the display control unit displays the selection image 30, which is displayed outside the prescribed range 24, on the upper side (not the lower side) of the prescribed range 24.

To make the user visually recognize the selection image 30 more easily, it is preferred that the display control unit enlarges and displays the selection image 30 to be displayed outside the prescribed range 24 so that the selection image 30 is larger than the selection image 20 within the prescribed range 24.

If the number of the selection images 20 is plural, it is difficult for the user to visually recognize the selection images 20 when the selection images 20 are hidden by the finger 32 or the like. Therefore, the first embodiment is more effective when the number of the selection images 20 hidden by the finger 32 or the like is plural.

In the first embodiment, even though the description was made of a case of a mobile phone terminal as an electronic device, other devices may be used. In a mobile electronic device such as a mobile phone terminal, the selection image 20 is small and easily hidden by an object such as the finger 32. The method in the first embodiment is especially effective to improve visibility of the user. All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that various changes, substitutions, and alterations could be made hereto without departing from the spirit and scope of the invention.

What is claimed is:

1. An electronic device comprising:
a display unit which displays a first selection image which is selectable by touching a screen with an object, and
a display control unit which controls display of a second selection image corresponding to the first selection image displayed within a prescribed range based on a position in which the object touches in the screen.

2. The electronic device according to claim 1, wherein the display control unit has the second selection image as a selection target when the object moves to the second selection image and is then separated from the screen.

3. The electronic device according to claim 1, wherein the display control unit deletes the second selection image when the object is separated from the screen.

4. The electronic device according to claim 2, wherein the second selection image corresponds to a link destination and the display control unit controls display of a screen of the link destination corresponding to the selected second selection image.

5. The electronic device according to claim 1, wherein the display control unit controls display of the second selection image along an outline of the prescribed range.

6. The electronic device according to claim 1, wherein the prescribed range is a range surrounding the position in which the object touches.

7. The electronic device according to claim 1, wherein the display control unit controls enlargement and display of the second selection image so that the second selection image is larger than the corresponding first selection image.

8. A displaying method executed by an electronic device, the method comprising:
displaying a first selection image which is selectable by touching a screen with an object, and
displaying a second selection image, which corresponds to the first selection image displayed within a prescribed range based on a position in which the object touches on the screen, the second selection image being displayed outside the prescribed range.

9. A computer readable storage medium storing a displaying program to be executed, by an electronic device, execution of the program causing the electronic device to perform a process comprising:
displaying a first selection image which is selectable by touching a screen with an object, and
displaying a second selection image, which corresponds to the first selection image displayed within a prescribed range based on a position in which the object touches on the screen, the second selection image being displayed outside the prescribed range.
